(19) United States
(12) Patent Application Publication
(10) Pub. No.: US 2003/0063222 A1
(43) Pub. Date: Apr. 3, 2003

(54) System and method for establishing TV setting based on viewer mood

(75) Inventors: Anthony Lionel Creed, San Diego, CA (US); Greg Gudorf, San Diego, CA (US); Aaron Dew, San Diego, CA (US); Matthew Chang, San Diego, CA (US); Rolf Toft, San Francisco, CA (US)

Correspondence Address: John L. Rogitz, Rogitz & Associates, Suite 3120, 750 B Street, San Diego, CA, 92101, US

(73) Assignee: SONY CORPORATION, Tokyo (JP)

(21) Appl. No.: 09/970,488

(22) Filed: Oct. 3, 2001

(51) Int. Cl. H04N 7/16; H04H 9/00; H04N 5/57; H04N 9/72

(52) U.S. Cl. 348/687; 725/10; 725/12; 348/692

(57) ABSTRACT

A system and method for establishing TV audio/video/program guide settings, based on a biosensor signal representative of viewer mood.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, in which preselected Internet pages are loaded once into a television during manufacture and never subsequently updated, with the preselected pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. The object of the present invention is to provide a TV system that accommodates lean back experiences better than existing systems.

### SUMMARY OF THE INVENTION

A system for automatically establishing at least one TV setting includes a biosensor engageable with a viewer for sensing an attribute thereof. Preferred, non-limiting biosensors include galvanic skin response (GSR) sensors, voice stress sensors, and iris sensors. A computer receives an output of the biosensor. A TV is engaged with the computer such that the computer can establish one or more settings of the TV based at least in part on the output. Preferred, non-limiting settings that are automatically established by the computer based on viewer mood include video settings such as contrast, color, and tint and audio settings such as volume and bass. Also, the setting can be a selection of TV channel or filtering of electronic program guide listings. Moreover, the settings also can vary based on time of day.

In another aspect, a method for establishing at least one setting on a TV includes measuring at least one biological attribute of a person, and based on the attribute, establishing the setting.

In yet another aspect, a system includes a TV with means for establishing a TV setting, and computing means that communicates with the TV. Sensing means are coupled to a human viewer and communicate with the computing means for sending a signal thereto representative of a mood of the human viewer. With this information, the computing means communicates with the TV setting means to establish the setting.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is a flow chart of the present logic.

### DETAILED DESCRIPTION OF THE PREFERRED EMBODIMENTS

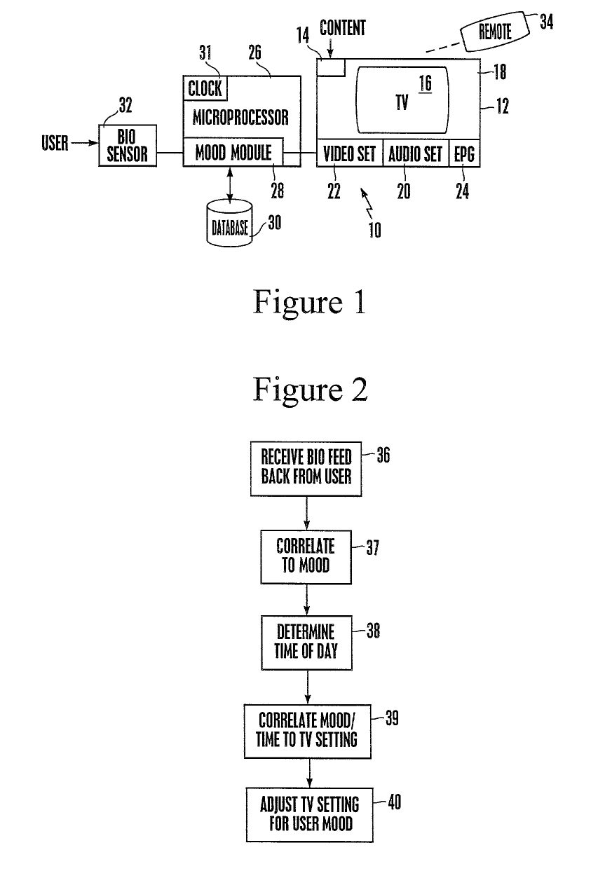

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16 and associated speakers.

While the embodiment below discusses a TV 12 with a single housing that is shown separate from the microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor discussed below.

In the preferred non-limiting embodiment shown, the TV 12 includes a housing 18 that holds a conventional television tuner which receives the TV signals. The audio and video settings of the TV, e.g., the volume, bass, treble, balance and other volume effects as well as the tone, tint, color, contrast, brightness, color temperature, and so on as well as other video effects as are conventionally provided in the art, are established by respective adjustable audio and video setting circuits 20, 22. Also, the TV 12 can access an electronic program guide (EPG) 24 for displaying, on the monitor 16, a list of available TV channels in accordance with principles known in the art.

A microprocessor 26 communicates with the circuits 20, 22 and the EPG 24. As discussed above, the microprocessor 26 can be located in the housing 18 or it can be disposed elsewhere, such as in a set-top box, remote control device, or indeed within the below-described biosensor. In any case, the microprocessor 26 accesses a software-implemented mood module 28 to execute the logic set forth herein. The microprocessor 26 can also access a database 30 of information for correlating biosensor signals to audio/video/EPG settings. The database 30 can be contained in computer memory, or on a hard disk drive, optical drive, solid state storage, tape drive, removable flash memory, or any other suitable data storage medium. Moreover, the microprocessor 26 accesses or includes a clock 31, so that the microprocessor can determine the time of day for purposes to be shortly disclosed.

It may now be appreciated that the microprocessor 26 controls the functions of the TV 12 in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

In the system 10 shown in FIG. 1, a biosensor 32 communicates with the microprocessor 26 via wired or wireless link. The biosensor 32 is any appropriate device that can be used to measure some biological attribute of a viewer of the TV 12. By way of non-limiting example, the biosensor 32 can be a galvanic skin response (GSR) sensor that can be attached to the skin of the viewer or otherwise coupled to the viewer in accordance with GSR principles known in the art. In one exemplary embodiment, the biosensor 32 can be a GSR sensor that is incorporated into the housing of a TV remote control device 34, so that when the viewer handles the remote device 34, the viewer's mood is sensed. Or, the biosensor can be a voice stress sensor to sense the level of stress in the viewer when the viewer speaks. Still further, the biosensor can be an iris dilation sensor or other eye sensor that is mounted, e.g., on the housing 18 of the TV 12 or as part of the microprocessor 26, when the microprocessor 26 is located separately from the housing 18. Blood pressure sensors, muscle tone sensors, and other sensors can also be used alone or in combination with each other.

In any case, the signal from the biosensor 32 is sent to the microprocessor 26. The mood module 28 accesses the database 30 and, if desired, the clock 31 to correlate the biosensor signal to TV 12 settings, which are then adjusted accordingly to suit the viewer's mood. For instance, a particular signal from the biosensor 32 might indicate quiet pensivity, in which case the audio circuit 20 might be adjusted automatically by the microprocessor 26 to establish a quiet volume. Further, the video circuit 22 can be adjusted automatically to establish one or more of color, tint, hue, brightness, contrast, and so on according to predetermined heuristics to match the particular mood of the viewer as indicated by the biosensor 32. Still further, the EPG 24 can be automatically established to highlight certain programs and lowlight or delete altogether programs that do not match the viewer's mood. For example, for a viewer whose mood is sensed as being sad, a channel carrying WWF wrestling might be lowlighted or not presented at all on the EPG 24. Or, a sad viewer might be presented with light, happy fare, as desired by the viewer. On the other hand, for a relaxed, happy viewer, EPG 24 channels carrying comedies or other light fare can be highlighted or presented exclusively. As can be appreciated, a wide range of subjective heuristics can be employed and updated in the database 30 via, e.g., cable or Internet connection.

Moreover, the mood module 28 can adjust TV 12 settings not only based on mood, but also based on time of day or by particular day (week day or weekend), in addition to or in lieu of mood. That is, using the time from the clock 31 exclusively or in addition to the signal from the biosensor 32, the microprocessor 26 can establish the settings of the audio circuit 20/video circuit 22/EPG 24. As an example, in the morning the volume of the TV 12 might be automatically set relatively high, and the EPG 24 might be configured to highlight morning news shows. These settings can be altered for a viewer whom the biosensor 32 indicates is depressed.

Still further, the viewer can manually change the mood setting by, e.g., appropriately manipulating the remote control device 34. In such an embodiment, the microprocessor 26 can present, on the monitor 16, a mood menu listing available moods and highlighting the actual viewer mood as sensed by the biosensor 32, and the viewer can scroll through the menu and select another mood (and, hence, cause the TV settings to be automatically readjusted), if desired.

These viewer-selected moods can in turn be correlated with contemporaneous signals from the biosensor 34 and the correlation database 30 updated, or “trained”, accordingly. For example, if the same mood signal (or signal range) is sensed two or more times contemporaneously with a manually-input mood, the signal (or range) can be correlated to the manually-input mood in the database 30.

The above overall logic is illustrated in FIG. 2. Commencing at block 36, the biosensor 32 signal is received from the viewer as a form of bio feedback. At block 37, the signal can, if desired, be correlated to mood. Also, in a non-limiting embodiment the time of day/day of the week can be ascertained at block 38. The bio feedback signal or the mood signal (modified, if desired, with time of day/day of the week) is correlated to one or more TV 12 settings at block 39, and then the settings are automatically established at block 40 as discussed above.

While the particular SYSTEM AND METHOD FOR ESTABLISHING TV SETTING BASED ON VIEWER MOOD as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A system for automatically establishing at least one TV setting, comprising:
at least one biosensor engageable with a viewer for sensing an attribute thereof;
at least one computer receiving an output of the biosensor; and
at least one TV engaged with the computer, the computer establishing at least one setting of the TV based at least in part on the output.

2. The system of claim 1, wherein the biosensor is a galvanic skin response (GSR) sensor.

3. The system of claim 1, wherein the biosensor is a voice stress sensor.

4. The system of claim 1, wherein the biosensor is an iris sensor.

5. The system of claim 1, wherein the setting is a video setting.

6. The system of claim 5, wherein the setting is contrast.

7. The system of claim 5, wherein the setting is color.

8. The system of claim 5, wherein the setting is tint, or brightness, or color temperature.

9. The system of claim 1, wherein the setting is an audio setting.

10. The system of claim 9, wherein the setting is volume, or bass, or treble, or balance.

11. The system of claim 1, wherein the setting is a TV channel.

12. The system of claim 1, wherein the setting is an electronic program guide.

13. The system of claim 1, comprising a correlation database storing correlations between outputs and settings.

14. A method for establishing at least one setting on a TV, comprising:
measuring at least one biological attribute of a person; and
based on the attribute, establishing the setting.

15. The method of claim 14, wherein the attribute is a galvanic skin response (GSR).

16. The method of claim 14, wherein the attribute is voice stress.

17. The method of claim 14, wherein the attribute is at least one of: an iris configuration, blood pressure, and muscle tone.

18. The method of claim 14, wherein the setting is a video setting.

19. The method of claim 14, wherein the setting is an audio setting.

20. The method of claim 14, wherein the setting is a TV channel.

21. A system, comprising:
at least one TV;
at least one TV setting means associated with the TV for establishing at least one setting thereof;
computing means communicating with the TV; and
sensing means coupled to a human viewer and communicating with the computing means for sending at least one signal thereto representative of a mood of the human viewer, the computing means communicating with the TV setting means to establish the setting.

22. The system of claim 21, wherein the sensing means is a galvanic skin response (GSR) sensor.

23. The system of claim 21, wherein the sensing means is a voice stress sensor.

24. The system of claim 21, wherein the sensing means is an iris sensor.

25. The system of claim 21, wherein the setting is a video setting.

27. The system of claim 21, wherein the setting is an audio setting.

28. The system of claim 21, wherein the setting is a TV channel.

29. The system of claim 1, wherein the computer establishes at least one setting of the TV based at least in part on a time of day or day of the week.

30. The method of claim 14, further comprising establishing the setting based on the time of day or day of the week.

31. The system of claim 21, further comprising time of day means coupled to the computing means for establishing the setting.
